(19) United States
(12) Patent Application Publication
(10) Pub. No.: US 2009/0271760 A1
(43) Pub. Date: Oct. 29, 2009

(54) Method for application development

(76) Inventor: Robert Stephen Ellinger, S. Setauket, NY (US)

Correspondence Address: ANDREWS KURTH LLP, 1350 I STREET, N.W., SUITE 1100, WASHINGTON, DC, 20005, US

(21) Appl. No.: 12/081,982

(22) Filed: Apr. 24, 2008

(51) Int. Cl. G06F 9/44

(52) U.S. Cl. 717/101

(57) ABSTRACT

A process and method for application development that conforms with Rapid Application Development (RAD) requirements and Software Engineering Institute (SEI) Software Capability Maturity Model Integrated (CMMI) Level 3 requirements. An application development process that conforms with Rapid Application Development (RAD) requirements and Software Engineering Institute (SEI) Software Capability Maturity Model Integrated (CMMI) Level 3 requirements includes one or more formally-named development cycles, one or more formally-named design cycles, in which each development cycle includes one or more formally-named design cycles, and one or more formally-named construction cycles, in which each design cycle includes one or more formally-named construction cycles.

### TECHNICAL FIELD

The technical field is application development, and more particularly, application and object oriented development processes.

### BACKGROUND

A web application is an application, possibly linked to one or more databases, which uses the web as the user interface. There are currently a number of different general types of application development processes that developers employ to develop applications and, in particular, web applications. There are, for example, lightweight development processes, rapid application development (RAD) processes, and highly structured organizational development processes, such as Software Engineering Institute's Software Capability Maturity Model Integrated Level 3 (SEI CMMI Level 3) conformant processes.

A lightweight development process is a development process that minimizes the number of intermediate steps, artifacts, and reviews. A rapid application development process is defined as a development process that creates software through a series of short development cycles. A SEI CMMI Level 3 conformant process is a highly structured organizational process with formal management procedures, which has a goal of producing high quality software.

Current web application development is driven by customers' needs for better, more complex, more dependable, and cheaper products with faster development time. Current SEI CMMI Level 3 conformant processes do not meet the cost and development time customer requirements because of the procedures used to implement the conformant process. They are heavy weight, meaning that they have many reviews and intermediate artifacts and they work on a “big bang” single software release, in which the process gradually and slowly works up to a release, with increasing costs and no return until the release.

Alternative methods include lightweight, RAD with incremental software releases. These methods include the Anderson RAD method, the Rationale Unified Process (RUP), the evolutionary spiral process, and the eXtreme Programming Process (XP). However, these processes are not SEI CMMI Level 3 conformant, which many customers require to insure quality performance and dependability.

The current heavyweight development processes, which are SEI CMMI Level 3 conformant, cannot meet the customers' cost and schedule requirements. They are too expensive and take too much time to produce an application. In many instances, by the time the application is rolled out, it is obsolete both from the perspective of technology and because the customer's requirements have changed in response to the business environment.

The current RAD processes were created in response to these problems, but they are very informal, meaning that they allow the developers to use any procedures and methods they deem useful. This creates two problems. First, there is no repeatability of the process. If a project creates high quality software one time, there is no reason to expect that it can do it a second time because there is no repeatability or definition for the process—it is dependent on the developers and their interaction with the customer. If a project creates low quality software, there is no way to identify what went wrong because there are no process metrics. Again, it is dependent on the development team and management, and their interaction with the customer.

### SUMMARY

The embodiments described herein provide a Web Application Development Method that overcomes these problems. The Web Application Development Method provides a lightweight, rapid deployment, development process for use in application, particularly web application, development that is Software Engineering Institue Capability Maturity Model Integrated Level 3 conformant. The web application development method satisfies customers' needs for better, more complex, more dependable and cheaper application products with faster development time. The web application development method provides a customer focused, low cost development process that produces a high quality product in a short time span. The Web Application Development Method provides a solution to the problem of integrating RAD techniques with the SEI Level conformant standards. No other process is known to solve this problem.

These and other advantages are provided by an application development process that conforms with Rapid Application Development (RAD) requirements and Software Engineering Institute (SEI) Software Capability Maturity Model Integrated (CMMI) Level 3 requirements. The process includes one or more formally-named development cycles, one or more formally-named design cycles, in which each development cycle includes one or more formally-named design cycles, and one or more formally-named construction cycles, in which each design cycle includes one or more formally-named construction cycles.

These and other advantages are provided by an application development method that conforms with Rapid Application Development (RAD) requirements and Software Engineering Institute (SEI) Software Capability Maturity Model Integrated (CMMI) Level 3 requirements. The method includes executing a development cycle, in which executing the development cycle identifies certain customer requirements for an application. The executing a development cycle includes implementing a planning game, in which implementing the planning game includes determining to meet the certain customer requirements during the development cycle and assigning work to meet the certain customer requirements and executing one or more design cycles, executing each of the one or more design cycles includes implementing a design cycle planning meeting, in which implementing the design cycle planning meeting includes designing components of the application to meet the certain customer requirements and executing one or more construction cycles to code and test the components of the application designed in the design cycle.

### DESCRIPTION OF THE DRAWINGS

The detailed description will refer to the following drawings, wherein like numerals refer to like elements, and wherein:

FIG. 1 is a diagram illustrating an embodiment of a web application development method;

FIG. 2 is a flow diagram depicting a high level view of an embodiment of the web application development method;

FIG. 3 is a flowchart illustrating a planning game method of an embodiment of the web application development method;

FIG. 4 is a flowchart illustrating a method of class design using CRC cards according to an embodiment of the web application development method; and,

FIG. 5 is a flowchart illustrating a method of construction according to an web application development method.

### DETAILED DESCRIPTION

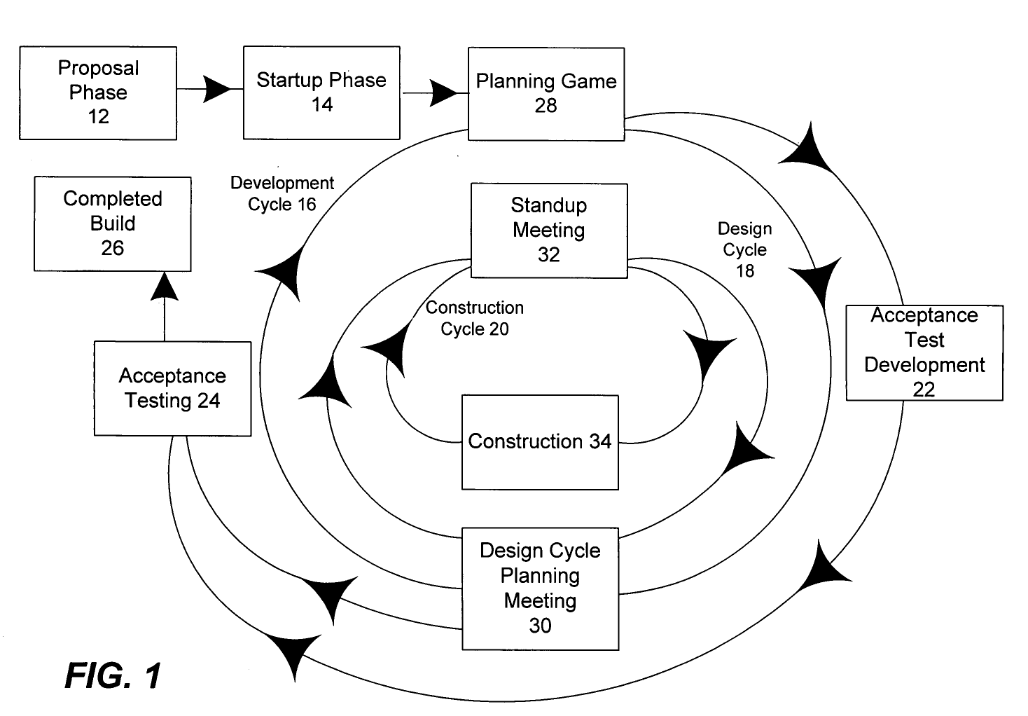

FIG. 1 illustrates an embodiment of a web application development method (WADM) 10. The WADM 10 is a lightweight, rapid deployment, development process for use in web application development that is SEI CMMI Level 3 conformant. The WADM 10 may be used for non-web object oriented application developments. The WADM 10 assumes that not all of the customer's requirements will be known. Accordingly, the WADM 10 is agile enough to adapt to customer requirements as they become known, or as new requirements are developed, during the development of the web application.

In the WADM 10, a customer requirements for the web application are defined as use-cases and design constraints. Use-cases, which are described in more detail below, are generally a way one type of user wants to use the application being developed. Each use-case is an element of the overall application. The WADM 10 divides the work necessary to complete the web application into units defined by the use-cases. In other words, the goal of each unit of work is to produce an element of the web application (e.g., a component) that will satisfy one or more use-cases. Design constraints, which are described in more detail below, are limitations that constrain the design of the web application. For example, a constraint might be that the application works on a certain operating system (e.g., Windows, Linux, UNIX). Constraints may be technical, business (e.g., schedule or cost), or cultural in nature. Together with the use-cases, the constraints define customer requirements for the web application. Design constraints are a novel concept in application development.

Conceptually, the WADM 10 preferably includes a proposal phase 12, a startup phase 14, a development cycle 16, a design cycle 18, a construction cycle 20, acceptance test development 22, acceptance testing 24 and a completed build 26. Each development cycle 16 preferably includes a planning game 28 and a plurality of design cycles 18, as shown in FIG. 1. The typical duration of the development cycle 16 is approximately four weeks and there is typically one development cycle per month. The development cycle 16 ensures that customer requirements, in a priority order set by the customer, are understood and met. In other words, the development cycle 16 identifies the customer requirements and validates that the requirements are met. The development cycle 16 is discussed in further detail below.

Each design cycle 18 preferably includes a design cycle planning meeting 30 and a plurality of construction cycles 20, as shown in FIG. 1. The typical duration of a design cycle 18 is one week. Accordingly, the development cycle 16 will typically include four design cycles 18. The design cycle 18 designs components of an application to meet a prioritized subset of the customer requirements. The design cycle 18 is discussed in further detail below.

Each construction cycle 20 includes a standup meeting 32, as shown in FIG. 1, and construction 34. The duration of a construction cycle 20 typically is one day. Accordingly, the design cycle 18 will typically include five construction cycles 20 (e.g., one for each business day in a week, although additional construction cycles 20 representing additional days may be included). The construction cycle 20 codes and unit tests components of the application designed in the design cycle. These are accomplished during the construction 34. The construction cycle 22 is discussed in further detail below.

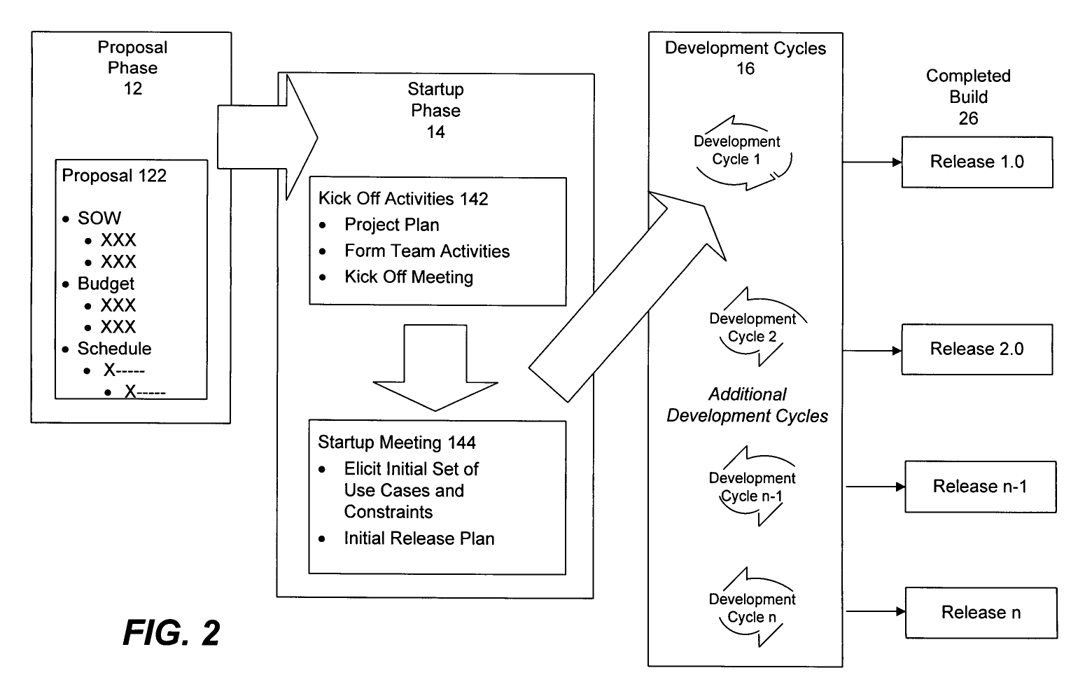

FIG. 2 is a diagram that provides a high level view of an exemplary WADM 10. As shown, the WADM 10 includes a proposal phase 12, a startup phase 14, a plurality of development cycles (development cycle 1, 2, . . . , n-1, n) 16, and a plurality of corresponding releases of usable software (release 1.0, 2.0, . . . , n-1, n) 26 (i.e., completed builds 26). There will be additional development cycles 16 until the budget for the application development project runs out or all of the customer requirements are met. Generally, the former occurs prior to the later.

### Proposal Phase

The proposal phase 12 preferably includes a preparing a proposal 122 for a web application development project. The proposal 122 is the developer's proposal for developing the customer's requested web application and is submitted to the customer. The proposal 122 includes a statement of work (SOW) describing the web application to be developed, a budget and a schedule. The SOW is prepared on the basis of a customer's request (e.g., RFP) for a web application. The proposal phase 12 may also be known as the estimate phase. This is because an estimate of the cost and schedule of the web application development project is preferably prepared as part of the proposal in the proposal phase 12. A summary estimate that includes a background of the project, the objective of the project, and a total estimate of cost and schedule for the project preferably is prepared.

The total estimate is prepared based on use-cases for the application and additional time and dollar costs (e.g., hardware costs). The SOW and the customer's request materials is used to determine and identify the initial use-cases. An estimate preferably is then calculated for each use-case. The estimate for each use-case may be determined by the complexity of the use-case, the risks or unknowns that need to be overcome in developing the application for the use-case and assumptions. Historical data on the costs and time needed for similar use-cases is used to calculate the estimate for a use-case. The total estimate is then prepared by combining the estimates for each use-case. From these calculations, it is seen that the total estimate is a function of four variables: the number of use-cases, the complexity of each use-case, and the risks of each use-case, and then the estimators' confidence in the first three variables and the bases for these variables.

Startup Phase

With reference again to FIG. 2, the startup phase 14 is shown to include kick off activities 142 and a startup meeting 144. The kickoff activities 142 includes developing initial use-cases, creating a project plan, forming a project team and holding a kickoff meeting. The developing step uses customer provided request material to create initial (or draft) use-cases. As discussed above, this step may also be performed in part or whole, during the proposal phase 12. The initial use-cases generally will not cover all of the customer requirements but are identified because it is easier for the customer to provide feedback to critique and revise use-cases than to create use-cases. The creating step develops an overall project plan for the web application development. The project plan may be prepared using a template that enables documenting of all the technical, administrative and procedural information needed to comply with SEI Level 3 standards in a repeatable fashion. Information will continue to be entered into the project plan document throughout the web application development project. Such a template is seen in the examples shown in Appendix A and Appendix B.

The forming step identifies the necessary members to fill team roles for the web application development project. The project team members are responsible for a web application, and the associated web site, throughout the web application lifecycle. The lifecycle includes development, maintenance, upgrade, and disposal of the web application and the web site. Typical team members may include, but are not limited to, a system engineer (web architect), a web server system support lead, a project lead, a project manager, development team member(s), database administration team member(s), business team member(s), graphics designer(s), and a SQA reviewer. Each team member, including the Business Team Member (the customer), has a clearly defined role and clearly defined responsibilities. The membership may be different for different applications. Of importance, the business team member(s) is the customer or a designated representative of the customer. The business team member provides the customer input and feedback and is integral to the WADM 10. The WADM 10, therefore, differs from previous approaches in that it includes high customer involvement, as described further below.

With further reference to FIG. 2, the kickoff meeting preferably has three main objectives: project team introductions, expectation setting and development method overview. Project team introductions include general introductions and identification of team members' roles and responsibilities. The expectation setting sets the expectations for the project, the project team and the team members. An important part of this step is communicating the expectation of a high level of involvement for the customer (or customer representative). The development method overview provides a high level description of the WADM 10 so that all project team members, especially the customer (i.e., business team member(s)) are familiar with the WADM 10. Preferably, no more than two hours is spent on the kickoff meeting.

The startup meeting 144 has a number of objectives including: defining team standards for the web application development project, recording the team standards in the project plan, and identifying and revising initial use-cases. The team defines standards for design, code formatting, code documenting, team operating rules (e.g., when should a development team stop working on a problem or bug and hand off the problem or bug to another development team), artifact standards (or work product standards), configuration management processes and directories, risk management data and document procedures, issue management data, and document procedures. The recording step records these standards into the project plan developed in the kickoff activities 142.

The identifying and revising initial use-cases step presents the initial use-cases developed in the proposal phase 12 and the kickoff activities 142. With the customer's (Business Team Member's) participation, the team revises initial use-cases (i.e., business team member(s)) to create a revised set of use-cases. The customer identifies what aspects of the initial use-cases are wrong and which use-cases correctly identify the customer requirements (see Appendix A). The customer also identifies initial design constraints documented in the requirement document. Typical constraints may specify that the web application must run on a particular operating system (e.g., Windows 2000, Linux, etc.) or use certain database software. The customer also helps to develop new use-cases that cover requirements not covered by the initial use-cases. These new use-cases are preferably included in the revised set of use-cases. Based on the revised set of use-cases, an initial release plan for the web application is preferably developed during the startup meeting 144.

Preferably, the startup meeting 144 has a duration no longer than four hours. On small and minor projects (projects of less than 750 hours), the project leader can choose to combine kickoff and startup meetings into a single meeting (e.g., one to two hours long). In total, the startup phase 14, including all of the activities described herein, will usually take at least one week.

Development Cycle

With reference to FIG. 1, each development cycle 16 includes a planning game 28 and a plurality of design cycles 18. The entire project team, including the business team member(s) (i.e., the customer or customer representatives), participates in the planning game 28. The planning game 28 includes determining what use-cases can be met with the next build/release/version (i.e., the completed build 26), given the web application development project's resources and the requirement to produce the next build/release/version within the approximately four week time period of the development cycle 16. The planning game 28 also includes assigning the work to development team members for the next build/release/version. The units of work assigned are the use-cases.

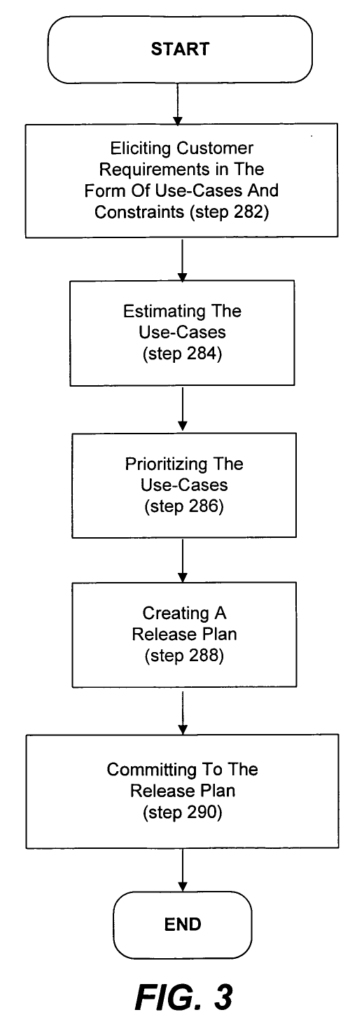

The determining and assigning steps are accomplished through a series of steps, which may be referred to as “moves,” in the planning game 28. FIG. 3 is a flowchart illustrating these steps. As shown, these steps include: eliciting customer requirements in the form of use-cases and constraints (step 282), estimating the use-cases (step 284), prioritizing the use-cases (step 286), creating a release plan (step 288), and committing to the release plan (step 290).

The eliciting step 282 is performed by the business team member(s) (i.e., customer or customer representative) and development team member(s) together. Specifically, the business team member(s) identifies the use-cases and design constraints and the development team member(s) document the identified use-cases and design constraints in a requirements document (see Appendix A). Use-case scenarios, use-case estimates, use-case-priorities, and completed use-cases are also documented in the requirements document (see below).

For a planning game 28 in the first development cycle 16 of a web application development project, the use-cases identified in the eliciting step 282 are the revised set of use-cases created in the startup meeting 144, although the use-cases may be further revised by the business team member(s) to include new use-cases or changes to existing use-cases. For a planning game 28 in later development cycles 16, (e.g., development cycle 2 in FIG. 2), then the eliciting step 282 identifies the use-cases not addressed in the previous development cycle (e.g., development cycle 1 in FIG. 1) and identifies new use-cases thought of by the business team member(s) (e.g., to meet new customer requirements) or new use-cases that arose during the previous development cycle.

The eliciting step 282, along with the identifying and revising initial use-cases step in the startup meeting, is part of requirements management performed by the WADM 10. An objective of the requirements management is clear communications of the customer's requirements to the developing team members. Clear communications means that the developer understands the customer and produces an application to meet the customer's needs. Customers have two types of requirements: programmatic and systemic. The programmatic includes the cost and schedule and the systemic includes performance (what the application is supposed to do) and dependability (how well the application does what it is supposed to do). Requirements management balances the programmatic and systemic. The greater the performance and/or dependability, the greater cost and/or schedule are needed to balance. Likewise, if cost and/or schedule are reduced, then performance and/or dependability necessarily are reduced. Risks, on the programmatic side, and constraints, on the systemic side, also are included in the balance. Greater risks may need to be accepted to balance greater performance and/or dependability without increasing costs or schedule. Likewise, adding constraints may require additional costs and/or schedule.

The WADM 10 meets the requirements management objective of clear communication through use-cases. With reference to FIG. 3, the eliciting step 282 determines these requirements by asking the business team member(s) who will use the application and what the users will use the application for. In other words, a way one type of user wants to use the application—a use-case. The eliciting step 282 preferably includes identifying the actors involved in the use-cases (e.g., user, potential user, content expert, customer, supplier, another application, etc.), identifying the use-cases by title (e.g., List of Use-Cases for Content Expert—Get Report 1, Get Document, Insert Data, Review Data, etc.), and defining the details for each use-case. The details of each use-case are preferably described by the following fields: name of use-case, summary of use-case, initiating actor, participating actor(s), pre-conditions, initiating condition(s), event flow, expected outcome, post conditions, exceptions and traceability. These fields are preferably included in the development team member(s) documentation of the use-case.

The name is a descriptive name of the use-case. The summary is a summary or description of an objective or objectives of the use-case. The initiating actor is who or what initiates the event flow to get the expected outcome. The participating actor(s) is who or what is effected by the event flow or expected outcome of the use-case (e.g., customer, supplier, another application, etc.). Pre-conditions are the status of the actors before the event flow (e.g., in a performance and salary review process, the pre-conditions would be the employee's job category/salary range, and the employee's current Salary). Initiating condition(s) is what triggers the use-case event flow (e.g., in the review process, the initiating condition, would be the organization's review schedule). The event flow is the steps executed from the initiating condition(s) to the expected outcome, via the shortest path, from the initiating actor's perspective. The expected outcome is the expected result(s) of the event flow, given the pre-conditions and the initiating condition(s). Post conditions are the conditions of all participating actors following the event flow to the expected outcome. Exceptions are what happens when an actor responds in an unexpected manner. Traceability indicates whether the use-case traces to another use-case. As is discussed below, a scenario is a use-case instantiated with data. Specifically, these fields are instantiated with the data. A set of scenarios corresponding to the use-cases included in the release plan are used for customer acceptance testing 24.

As mentioned above, with reference to FIG. 3, the eliciting step 282 also elicits the design constraints. The customer requirements comprise the use-cases and the constraints. The constraints include technical constraints (e.g., application program interface (API) requirements, formats (e.g., must use XML), data stores (e.g., what data is needed, where data is located, etc.), etc.), business constraints (e.g., algorithms, business processes (e.g., must meet Commonly Accepted Accounting Practices, or is the procedure formally documented, to perform configuration management), customer provided equipment, etc.), and cultural constraints (e.g., frequently, organizations will have a cultural bias toward one technology or supply and away from a competing technology or supplier). The constraints are also documented by the development team member(s).

With continued reference to FIG. 3, the estimating step 284 estimates the use-cases elicited in step 282. The development team member(s) performs the estimating step 284. The estimate is the amount of time needed to develop application (e.g., a module) for the use-case. The estimate is based on complexity and risks. The complexity of a use-case is the length of the shortest possible set of events in the event flow from the initiating condition(s) until the expected outcome. The risks are the unknowns involved in developing the use-case. For example, the development team member(s) may not know how to achieve a step in the event flow. This unknown is a risk that likely will increase the estimate.

The estimating step 284 is performed, for example, by analogy (i.e., experience-based) or by using a use-case database. An exemplary analogy method includes determining the complexity, determining the risks, and estimating the total number of hours to develop application for the use-case based on previous experience. The complexity determining step is performed, for example, by counting the number of steps in the use-case event flow. The risk determining step is performed by creating a notional design (e.g., a rough conception of a functional design of the use-case) and identifying all aspects of the notional design that the development team member(s) does not know how to complete (e.g., aspects marked “then the miracle occurs”). Such aspects may include business algorithms, programming steps, functions, or components, formatting of user interfaces, etc. The estimating step follows guidelines including: more complexity equals more hours; more risks equals more hours; and re-use of existing code equals less hours. The using a use-case database method simply replaces the estimating based on previous experience step with a step of searching for analogous use-cases, and associated information indicating the hours spent developing application for the analogous use-cases, in a use-case database. The result of the estimating step 284 is the total labor hours required to develop application for the use-case (i.e., the use-case development time). The estimating step 284 is repeated for each use-case elicited in step 282.

The prioritizing step 286, shown in FIG. 3, prioritizes the use-cases in the order in which application will be developed for the use-cases. The business team member(s) performs the prioritizing step 286. The priority may be based on, for example, the simplest use-cases (e.g., the least complex and fewest risks use-cases), the hardest use-cases (e.g., the most complex and highest risk use-cases), or a useable subset of use-cases (e.g., to create a functioning application, but not the complete application).

The creating step 288, shown in FIG. 3, creates a release plan for the application based on available hours, the estimates for the use-cases and the use-case priority. The development team member(s) performs the creating step 288. The creating step 288 includes determining a load factor for the development team member(s), determining the total available time during the current development cycle 16, and dividing the prioritized cases into builds (i.e., from highest priority use-cases choose use-case for the current development cycle 16). The load factor is defined as the number of development team members multiplied by the percentage of hours each developer is available. For example, if there are four development team members and each team member is available thirty percent of the time, then the load factor is 1.2. The determining the total available time step multiplies the number of potential construction cycle hours until the next delivery (i.e., until the next completed build 26) by the load factor. For example, if there are 190 potential construction cycle hours available until the next delivery and the load factor is 1.2, there are 192 development team member hours available in the current development cycle 16.

The dividing step includes assigning the highest priority use-case to the development team member(s), subtracting the use-case development time, estimated in the estimating step 284 for that use-case, from the total available time during the current development cycle 16, repeating the assigning and subtracting steps for the next highest priority use-case, and, when there is no more available time for the current development cycle 16, repeating the assigning and subtracting steps for the next development cycle 16. The dividing step is continued until all use-cases are assigned to a development cycle 16. The creating step 288 also includes development team member(s) documenting into which development cycle 16 each use-case is assigned. For planning games 28 in development cycles 16 after the first development cycle 16, the development team member(s) also documents the use-cases completed in the previous development cycle (e.g., for requirements tracking and auditing purposes). This information is documented in the same document in which the use-cases and constraints are documented in the eliciting step 282.

With reference again to FIG. 3, the committing step 290 includes each project team member, especially including the business team member(s), committing to the release plan created in the creating step 288. In this manner, agreement and communication between the development team member(s) and the business team member(s) is ensured.

As opposed to previous method, the WADM 10 does not allow requirements creep. If a new customer requirement is added, it is in the form of a new use-case or constraint. Each new use-case is separately estimated and prioritized in the planning game 28. If the customer does not provide additional funding for the new use-case then either application is not developed for the new use-case—if a low priority use-case or application is not developed for a lower-priority use-case(s). As a result, application is developed for the highest priority use-cases, but, application may not be developed for some use-case by the time the application development project is completed. However, this can be easily traced to the priorities set by the customer and the funding provided by the customer, as documented by the development team member(s) and committed to by the customer in the committing step 290. Consequently, the customer has no legitimate complaint.

Design Cycle

As stated above with reference to FIG. 1, each design cycle 18 includes a design cycle planning meeting 30 and a plurality of construction cycles 20. The entire project team, but at least the development team member(s) and the business team member(s), participates in the design cycle planning meeting 30. The design cycle planning meeting 30 is provides an opportunity for the customer to come in on a weekly basis and see what the development team member(s) are doing. This enables mid-course corrections and communication of new and additional requirements that the customer may have.

The design cycle planning meeting 30 includes designing components of the web application based on the use-cases, managing issues, requirements and risks that arise, and ensuring that the application development project stays on schedule. The designing step is performed using an object-oriented design approach. The designing step may be accomplished using class, responsibility, collaborator (CRC) cards or unified modeling language (UML) diagrams. Other object-oriented design tools may be used. The designing step designs a set of classes based on the use-cases for which application is being developed in the current development cycle. The designing step may also enlarge a design to incorporate functions required to perform additional use-cases.

Class identifies the name of the object class. Responsibility identifies the procedures or functions for which the object class is responsible and/or the states of the class. Collaborator identifies the interfaces from the object class to all other classes. Below is an exemplary blank CRC card:

Class

| | |
|---|---|
| Responsibility | Collaborator |

It is helpful here to describe components and classes here. A component is simply a piece of code written to enable and support some IT or business function in an application. However, a component is autonomous with clearly implemented interfaces (also called APIs). A class is a set of components/code snippets or small autonomous applications that all have the same set of attributes or characteristics. For example, if your car is a 56 Chevy convertible, your car would be an instance of a 56 Chevy, which would be a sub-class of all Chevy's which, in turn would be a sub-class of GM cars, which in turn would be a sub-class of Cars. Therefore, Car could be represented in a simulation, which would have certain attributes. One of its sub-classes could be GM-cars, etc. down to representing your car and all of its attributes (including license plate number, any scratches and dents-particular to that car. A module, which is discussed below, is an application that operates as a part of a larger application and is implemented to tightly integrate with other modules in that larger application. Modules can be components.

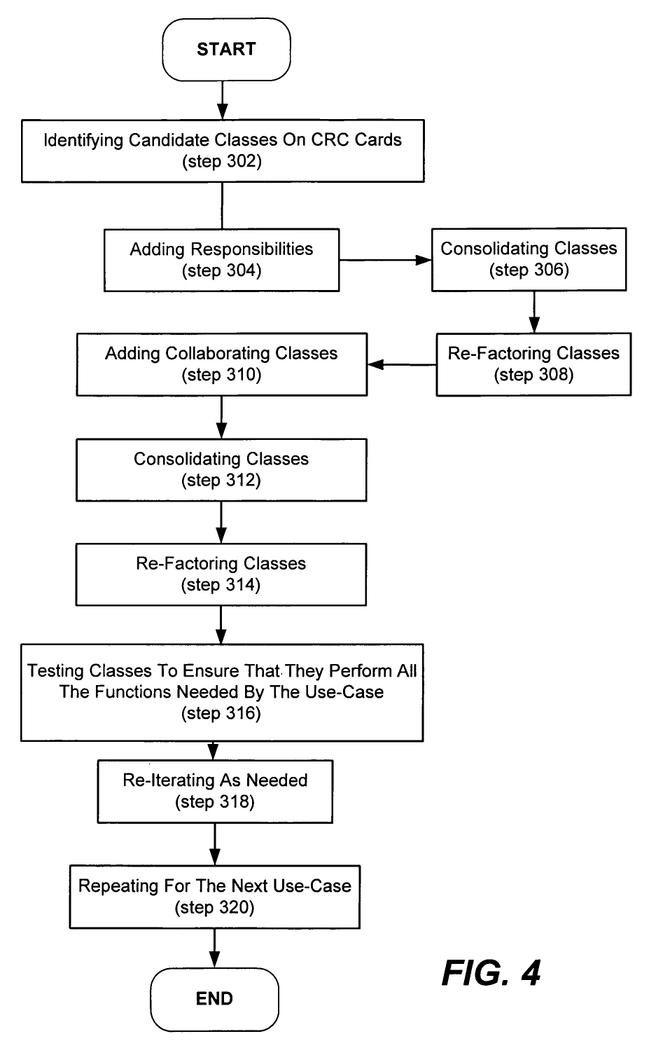

FIG. 4 illustrates an exemplary method 300 of class design using CRC cards. Starting with the highest priority use-case assigned to the current development cycle, the method 300 includes identifying candidate classes on CRC cards (step 302), adding responsibilities (step 304), consolidating classes (step 306) and re-factoring classes (step 308) based on responsibilities, adding collaborating classes (step 310), consolidating classes (step 312) and re-factoring classes (step 314) based on collaborating classes, testing classes to ensure that they perform all the functions needed by the use-case (step 316), re-iterating as needed (step 318), and, repeating for the next use-case (step 320).

The identifying step 302 derives candidate classes from the use-case. Classes include things that act - e.g., transform input(s) into output(s). All actors in the use-case are candidate classes. The identifying step 302 is over-inclusive since the initial set of classes identified by the identifying step 302 will likely be reduced in the method 300. The identified classes are each written on a CRC card.

With reference to FIG. 4, the adding responsibilities step 304 derives responsibilities from the use-case. The adding step 304 adds responsibilities for requests that are handled by the candidate classes or for information the candidate classes keep track of, as well as for any other procedures or functions the candidate classes use. If responsibilities are identified that do not belong to a candidate classes, then a class is missing and needs to be added. The added responsibilities are written on the appropriate CRC card.

The consolidating step 306 eliminates one or more classes and takes all of the responsibilities of the one or more classes and writes them into a different class. The consolidating step 306 performs these functions when two (or more) classes have essentially the same responsibilities or two or more classes each have responsibilities for tracking portions of the same information. The consolidating step 306 may perform these functions by writing all the responsibilities from the to be consolidated classes on one CRC card and throwing the other CRC cards out. The CRC cards are then reordered in the order in which the functions of each class are performed.

The re-factoring step 308 logically divides classes (consolidated or otherwise) into two or more classes when one class has two many responsibilities, two or more classes have two or more sets of overlapping responsibilities and/or two or more classes each have responsibilities for two or more types of information. The re-factoring step 308 logically divides classes by consolidating all the to be re-factored classes into a single class (as in the consolidating step 306), dividing the responsibilities logically into new classes by creating new CRC cards, and throwing out the re-factored class CRC cards. The CRC cards are then reordered in the order in which the functions of each class are performed.

The adding collaborating classes step 310 adds collaborating classes that interface to or from the object class on each CRC card. Collaborations assert interactions among classes and structure of the classes. There is always a collaboration when one class needs information from another class—the adding collaborating classes step 310 identifies the collaborating steps in this manner. Collaborations may be hierarchical and allow for inheritance of information. Alternatively, collaborations may be relational and allow for peer-to-peer interactions. If there are multiple classes and there is a class without a collaborating class, then the class without collaborations is probably an error. The added collaborating classes are written on the appropriate CRC cards.

With reference to FIG. 4, the consolidating step 312 and re-factoring step 314 are performed based on collaborations as described above in steps 306 and 308. Classes are consolidated 312 when a set of two or more classes are tightly coupled (e.g., when using one class requires the use of all other classes in the set). A class is divided when there are two or more independent sets of collaborations in the class (e.g., class A collaborates with classes B, C, D and E, classes B and C collaborate, classes D and E collaborate, but, classes B and C do not collaborate with classes D and E—classes B and C and classes D and E are two independent sets of collaborations in class A). The CRC cards are then reordered in the order in which the functions of each class are performed.

The testing step 316 tests the complete set of CRC cards (the design) and determines whether all the functions required by the use-case are performed, and in the proper order, by the classes. The testing step 316 also determines whether all the functions performed are needed by the use-case. The testing step 316 may include placing the CRC cards on a table or wall (or other flat surface) in hierarchical and relational structure, walking through the initial conditions of the use-case, the steps in the event flow of the use-case and the post-conditions of the use-case, and determining if all conditions and events are in proper order, if there are no missing functions and if there are no redundant functions. If so determined, then the design passes the test. The initial conditions may be varied (e.g., per use-case exceptions) and these steps repeated to further test and increase confidence in the design. If the design is not the first use-case, then the design should be tested against previous use-cases. Some responsibilities and collaborations may pertain to other use-cases. If any conditions and events are not in proper order, there are missing functions and/or there are redundant functions, the design does not pass the test.

With reference to FIG. 4, if the design does not pass the test or the design is otherwise unsatisfactory, then the method 300 may be re-iterated 318. The re-iteration step 318 may re-iterate the method 300 from the identifying step 302, the adding responsibilities step 304, the consolidating or re-factoring steps 306, 308, 312 or 314 or the adding collaborating classes step 310, depending on the errors determined in the testing step 316 or the reason for dissatisfaction. Once the design passes the testing step 316 for the use-case and all previous use-cases, if any, and is otherwise satisfactory, the method 300 is repeated for the next use-case step 320 until all the method 300 has been performed for each use-case.

UML class design is used for complex class designs in large development efforts. The UML class design is created using multiple object views including: interface descriptions; analysis class and attribute identification; pattern analysis diagrams; sequence diagrams; state machine diagrams; activity diagrams; derived attribute diagrams; and, others. The advantages of using UML class design include that UML class design reduces risks of poor object design (which can kill an object oriented project), highly documents objects, methods, interfaces and attributes. Disadvantages of using UML class design include that UML class design adds significant time to object design, adds to necessary configuration management activities, requires formal training and continuous practice, and diagrams are not entirely standard.

Construction Cycle

As stated above with reference to FIG. 1, each construction cycle 20 includes a standup meeting 32 and construction 34. As noted above, each construction cycle 20 lasts one day. A standup meeting 302 includes identifying technical issues that have arisen since the previous day (i.e., since the previous construction cycle's 20 standup meeting 32), closing the identified technical issues; identifying new use-cases, if any, identifying and disposing risks, and sharing status of construction activities. The standup meeting 32 is typically fifteen minutes and is not supposed to last more than a half hour. The standup meeting 32 may be held sitting down.

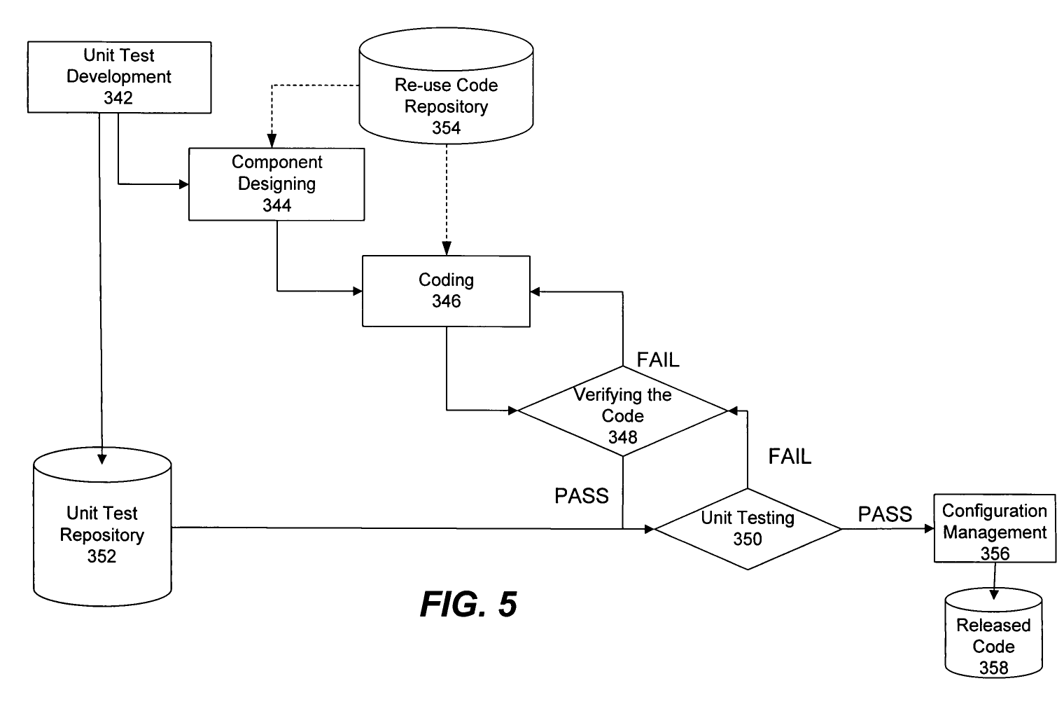

The construction 34 comprises the actual building of the web application. Construction 34 includes a unit test framework and the actual development. As shown in FIG. 5, the construction 34 includes component designing 344, coding 346, and verifying code 348. The unit test framework includes unit test developing 342 and unit testing 350. Unit tests created in the developing step 342 are stored in a unit test repository 352 for use in the testing step 350. Typically, each developer team of developers will perform two to four iterations of the construction 34 per day.

The component design step 344 uses the CRC cards (or the UML class design) from the design cycle 18 to create a detailed design of the component that is to be coded in the coding step 346. The detailed design may be an outline, a flowchart, and/or other tools used to provide a detailed design for the code. The component may be, for example, a method, procedure, single class, a collection of classes, or a module that includes one or more classes (e.g., all based on one or more CRC cards).

The coding step 346 is the actually writing of the code, performed by one or more development team members (the developer(s)). The developer(s) writes the code based on the detailed design from the component design step 344. Written code is stored in a re-use code repository 354. The developer(s) may re-use this stored code in the coding step 346. For example, if there is code in the repository 354 for a component similar to the component being coded in the coding step 346, the developer(s) may re-use that code. As shown in FIG. 5, the code in the repository 354 may also be used in the design step 344 to prepare the detailed design.

The verifying code 348 step includes some manner of review of the code for defects and other errors. If the code passes the verifying step 348, the unit testing 350 is performed. If the code fails the verifying step 348, the coding step 346 is repeated. A purpose of code verification is to detect and remove defects from the web application early and efficiently. A corollary effect is development of a better understanding of the application by the development team and of defects that may be prevented. Code verification is achieved by peer review. Peer review involves a methodical examination of software work products by the developer(s)'s peers to identify defects and areas where changes are needed.

To meet the SEI Level 3 requirements, the peer review activities of the verifying step 348 are planned and the defects in the software are identified and removed. The peer review activities include planning the peer review procedure and documenting the plans, performing the peer reviews according to the documented procedures, and recording data on the conduct and results of the peer reviews.

There are a variety of peer review methods for performing the verifying code step 348. One example is informal defect review. Informal defect review includes the review of the completed code from the coding step 346 by one or more peers of the developer(s) per the peer review procedure. The informal defect review may be performed by a team of peers. The informal defect review is performed according to a informal defect review standard. Such standards are typically internal. An informal defect review is a formal checkpoint or type of review with specific requirements as defined in the CMMI model. Performing the review according to a standard will generally require documentation such as, for example, a defect review worksheet and a defect review summary.

Another alternative peer review method for performing the verifying code step 348 is egoless programming. Egoless programming is performed by a two-person (or more) developer team. Egoless programming actually involves the component designing 344 and coding 346 steps, as well as the verifying code step 348 and the unit testing step 350 seen in FIG. 5. The two-person developer team may also jointly perform the unit test developing test 342. The two-person developer team jointly performs the component designing step 344. The two-person developer team then performs the coding step 346 by separately coding different portions of the component. The two-person developer team then performs the verifying code step 348 by each member of the two-person developer team then reading and review the code written by the other member. Each member spends at least one hour per day reviewing the other member's code. The code is read early and often by each member. Egoless programming does not allow code integration unless the code is reviewed by the other team member. Because of this, each member of the team has read the code and, presumably, understands it. After the code has passed the verifying code step 348, the two-person developer team jointly performs the unit testing 350 (see below).

Yet another alternative peer review method is pair-programming. With continued reference to FIG. 5, pair-programming is performed by two developers working at a single work station to perform all of the construction 34 steps. However, when pair programming is used, the construction 34 does not include a separate verifying code step 348. This is because the pair programming involves continuous peer review. Typically, one developer writes the code while the other developer reviews. Generally, this method produces simpler designs and code, taking advantage of the redundancy of the developers' code expertise, and minimizes review time.

The decision of what peer review method is used for the verifying code step 348 is made by the development team member(s) prior or during the startup meeting 144. The peer review method chosen is documented as described above and put into the project plan.

With reference again to FIG. 5, the unit testing framework verifies that the new code in a component (i.e., developed during the current construction 34) meets the design objectives and does not create a defect in previously validated code, if any. Previously validated code is code previously developed, validated and integrated during the current or previous construction cycles. This verification requires a complete retest of the previously validated code plus a testing of the new code. The unit test developing step 342 creates a unit test to test the component developed during the construction 34. The developer(s) creates the unit test. The unit test verifies that the component works as it was designed. A unit test is a routine(s) that verifies that the functions or features coded in the component performs as expected. As illustrated in FIG. 5, the developer(s) stores the unit tests in the unit test repository 352. The unit test repository 352 is established at the start of the web application development project.

The unit testing step 350 may be run automatically if the unit tests are created in a unit test program that inserts data into the code so that results are generated and checked against the expected outcomes (e.g., from the CRC cards from the design cycle 18). Alternatively, the unit testing step 350 may be run procedurally (i.e., manually) whereby the developer(s) documents the data to be inserted and the results, and then checks the results against the expected outcomes. The unit testing step 350 is performed manually, for example, for user interface components. The unit testing step 350 performs all the unit tests in the unit testing repository 352 to test the part of the web application under development (i.e., the previously validated code and the new code). The component does not pass the unit testing step 350 unless all of the unit tests are passed by the previously validated code and the new code. If the component fails the unit testing step 350, the component goes back to the design step 344.

With reference again to FIG. 5, the construction 34 also includes configuration management 356. Configuration management occurs throughout WADM 10. Configuration management 356 ensures that the customer gets the final version of the application that the development team created, and not some intermediate version. Configuration management 356 also ensures maintenance and upgrades are done on that product and that testing is done on the correct release of the application. Therefore, configuration management 356 is a waste reduction and quality improvement mechanism.

Once a component developed during a construction 34 passes the peer review of the verifying code step 348 and the unit test 350, configuration management 356 is performed to integrate the new code to the previously validated code, thereby validating the component. The developer(s) moves the new code from the developer's system to a central repository and attempts to integrate the new code into the previously validated code. If the developer(s) is unable to integrate the new code into the previously validated code (e.g., there is a defect found in the component's interface), the component is rejected and the developer(s) re-executes the construction 34 for the component. If the component is successfully integrated, the new code is released code 358, as part of the previously validated code, and ready for acceptance testing 24.

Acceptance Testing Process

With reference again to FIG. 1, the acceptance testing process includes the acceptance test development 22 and the acceptance testing 24. The acceptance tests are programmed or procedural versions of the scenarios directly traceable to the use-cases—the customer requirements (together with the constraints). The acceptance test development 22 includes the business team member(s) creating scenarios for the use-case(s) assigned to the current development cycle. Scenarios are created by creating instance(s) of the use-cases with data. The scenarios indicate expected outcomes for the instantiated data. The acceptance test development 22 further includes the development team member(s) documenting the scenarios in the requirements document, determining whether the acceptance testing will be automated or procedural, coding or documenting the acceptance test, based on the scenarios, based on whether automated or procedural, and inserting the acceptance test into an acceptance test repository (not shown).

The acceptance tests are coded or documented to test the integrated code developed during the current development cycle 16. Previous acceptance tests developed during earlier development cycles 16, if any, and stored in the acceptance test repository are used to re-test the earlier developed code. In this manner, the application is tested to verify that newly developed code, updates, etc., do not introduce errors or bugs into the application.

The acceptance tests determine if the data from the scenarios is input into the application, then will the expected outcomes occur. If the acceptance tests are passed, then the customer cannot state that the customer requirements were not met, since the acceptance test re based on the scenarios and, therefore, the use-cases. The acceptance testing 24 includes locking the application on a central repository, migrating the locked application to a staging system, testing the application with all of the acceptance tests and performing inspection testing to verify that the constraints are met. The testing the application with the acceptance tests performs the acceptance tests with the tests from prior development cycle(s), if any, first.

Completed Build

If the application passes all of the acceptance tests then the application is a completed build 26. The completed build 26 may be migrated to production. Typically, the completed build will not be produced if the application needs further development to be a working application (i.e., the use-cases assigned for the current development cycle did not result in a working application).

Typically, whether migrating code (the completed build 26) to production and/or gathering new use-cases (see below), there is approximately a week between development cycles 16. Hence, as noted above, there are typically four weeks in a development cycle 16 and one development cycle 16 per month. Note, that these times are variable.

Feedback Loop

If the application needs further development to be a working application, or if there are otherwise uncompleted use-cases and remaining budget, the next development cycle 16 is executed, and the WADM 10 repeats. Likewise, if the application does not pass all of the acceptance tests, then the application is plowed-back into the WADM 10 and a new development cycle 16 is executed. This is an analogous situation to there simply being new and/or uncompleted use-cases, in that a failed acceptance test indicates an unsuccessfully completed use-case. New use-cases may result from feedback from development team member(s) during design cycles 18 to the next planning game. The business team member(s) may also come up with new use-cases during the next planning game, in between development cycles 16 or otherwise. The feedback from development team member(s) may also include new risks.

Issue Management

The WADM 10 includes an issue management procedure to handle issues (problems) that arise during execution of the WADM 10. The issue management procedure is preferably SEI SW CMM and SEI SW CMMI Level 3 conformant. issue is a problem that has technical, cost and schedule impacts. The startup meeting 144 documents the issue management procedure in the project plan. The development team member(s) execute the issue management procedure when issues arise during the design cycle 18 and the construction cycle 20. The issue management procedure includes identifying an issue (ideally as early as possible), assessing the issue (e.g., determining the impact of the issue on the web application development project), determining disposition of the issue, planning closure of the issue, executing closure plan, and reporting status of the closure plan.

The identifying step documents the issue in an issue management document (e.g., in an issue spreadsheet). The assessing step also document the assessment in the issue management document. Disposition includes either redesigning to avoid the issue, transferring the issue to project team member that can resolve the issue, or executing a set of actions to resolve the issue. The determining step is based in part on the assessment and documents the determined disposition in the issue management document. Planning closure creates a plan based on the determined disposition of the issue and documents the plan in the issue management document. Executing closure plan executes the planned disposition of the issue. Reporting status reports the executed status of the closure plan, documenting the status in the issue management document. The issue management procedure also includes tracking and reporting on all issues, as identified in the issue management document. If there are outstanding non-closed issues, these are discussed at the next standup meeting 32.

Risk Management

The WADM 10 includes a risk management procedure to handle the risks (unknowns) that arise or are identified as described above. The risk management procedure is preferably SEI SW CMM and SEI SW CMMI Level 3 conformant. Risks can have technical, cost and schedule impacts. Risks are unknowns in the designs, (i.e., “how to” meet a requirement. The startup meeting 144 documents the risk management procedure in the project plan. The development team member(s) execute the risk management procedure when risk arise during the startup phase 14, the planning game 28, the design cycle 18 and the construction cycle 20. The risk management procedure includes identifying a risk, assessing the risk (e.g., probability of the risk occurring and the impact of the risk on the project), determining disposition of the risk, planning disposition of the risk, executing disposition, and reassessing the risk.

The identifying step documents the risk in a risk management document (e.g., in a risk spreadsheet). The assessing step also document the assessment in the risk management document. Disposition includes either redesigning to avoid the risk, accepting the risk (e.g., because the impact is low enough and/or the probability is low enough), transferring the risk to a project team member that can resolve the risk, or studying the risk to make it a non-risk (a known). The determining step is based in part on the assessment and documents the determined disposition in the risk management document. Planning disposition creates a plan based on the determined disposition of the risk and documents the plan in the risk management document. Executing disposition plan executes the planned disposition of the risk. The reassessing step re-assess the probability and impact of the risk, if any, and documents the reassessment in the risk management document. The risk management procedure also includes risk tracking and reporting on all risk, as identified in the risk management document. If there are unresolved risks, these are preferably discussed at the next standup meeting 32.

Documentation and SQA Review

The WADM 10 includes an SQA (Software Quality Assurance) review at the startup phase 14 and at the end of each development cycle 16. The SQA review includes the completion of the documentation described above. The SQA review, the documentation and the documenting procedures described herein are preferably SEI SW CMM and SEI SW CMMI Level 3 conformant. At the end of the startup phase 14, the documentation includes a completed project plan, which includes a SOW, an estimated cost and a high-level schedule, an initial use-case based requirements document, which includes initial use-cases and constraints, an initial release plan, which is later completed during the planning game 28 to include a detailed loaded schedule of the development team member(s) and the commitment of the business team member(s) and the development team member(s), an initial set of risks, and a location of documents for issues, risks and actions (e.g., the issue and risk management documents). At the end of a development cycle 16, the documentation includes an update of the release plan, an update of the requirements document, if changed, an update of the documents for issues, risks and actions, the approved build, and the tests developed during the development cycle 16, including unit tests and acceptance tests (e.g., in the unit and acceptance tests repositories, respectively).

If additional use-cases are discovered (e.g., because customer failed to clearly communicate, failed to identify a requirement or identified a plurality of use-cases as one use-case), the new use-cases are sent to the next planning game for prioritizing, estimating and assigning. Either lower priority use-case(s) will not be completed or extra funding will be provided by the customer. If a use-case turns out to require more hours than planned (e.g., unidentified risks, more complex or is really a plurality of use-cases), the residual work is sent to the next planning game for prioritizing, estimating and assigning. Potentially, the customer's lowest priority use-case(s) may not be completed without more funding. If a use-case takes less work than planned (e.g., immediate risk mitigation, re-use of code simplifies construction, only needed minor modifications to previously built functions), work is begun on the next highest priority use-case or the next planning game may be held earlier (the development cycle 16 is sped up). This may free up budget funds for delays and additional use-cases, provide money back to the customer or cause the web application project to be completed earlier. If a component fails acceptance testing because it fails customer expectations, but meets scenario criteria, a new or revised use-case needs to be developed in the next planning game.

1. An application development process comprising:
one or more formally-named development cycles;
one or more formally-named design cycles, wherein each development cycle includes one or more formally-named design cycles;
one or more formally-named construction cycles, wherein each design cycle includes one or more formally-named construction cycles; and,
wherein the application development process conforms with Rapid Application Development (RAD) requirements and Software Engineering Institute (SEI) Software Capability Maturity Model Integrated (CMMI) Level 3 requirements.

2. The application development process of claim 1, further comprising:
a SEI SW CMM Level 3 conformant risk management process.

3. The application development process of claim 1, further comprising:
a SEI SW CMM Level 3 conformant issue management process.

4. The application development process of claim 1, further comprising:
a SEI SW CMM Level 3 conformant software quality assurance (SQA) process.

5. The application development process of claim 1, further comprising:
a SEI SW CMM Level 3 conformant documentation process.

6. The application development process of claim 1, further comprising:
a use case based estimating process that utilizes one or more use-cases.

7. The application development process of claim further comprising:
a use case based earned value process that bases earned value on the number of use-cases that are completed.

8. The application development process of claim 1, wherein the one or more development cycles identify certain customer requirements for an application and include holding a planning game, wherein each planning game includes determining to meet the certain customer requirements during a development cycle and assigning work to meet the certain customer requirements.

9. The application development process of claim 8, wherein the one or more design cycles include holding a design cycle planning meeting, wherein the design cycle planning meeting includes designing components of the application to meet the certain customer requirements.

10. The application development process of claim 10 further comprising acceptance test development based on use-cases, wherein acceptance tests are used to test whether the coded components of the application meet the certain customer requirements.

11. An application developed using the application development process of claim 1.

12. The application of claim 1, wherein the application is a web application

13. An application development method comprising steps of:
executing a development cycle, wherein executing the development cycle identifies certain customer requirements for an application, the executing a development cycle further including:
implementing a planning game, wherein implementing the planning game includes determining to meet the certain customer requirements during the development cycle and assigning work to meet the certain customer requirements; and
executing one or more design cycles, wherein executing each of the one or more design cycles includes:
implementing a design cycle planning meeting, wherein implementing the design cycle planning meeting includes designing components of the application to meet the certain customer requirements; and
executing one or more construction cycles to code and test the components of the application designed in the design cycle; and
wherein the application development method conforms with Rapid Application Development (RAD) requirements and Software Engineering Institute (SEI) Software Capability Maturity Model Integrated (CMMI) Level 3 requirements.

14. The method of claim 13, wherein the executing each of the one or more construction cycles further includes:
implementing a standup meeting; and
constructing the designed components.

15. The method of claim 14, wherein the constructing step includes:
coding the designed components;
verifying the code from the coding step; and
unit testing the verified code.

16. The method of claim 15, wherein the verifying step includes egoless programming.

17. The method of claim 14, wherein the standup meeting is approximately thirty minutes.

18. The method of claim 13, wherein the customer requirements include use-cases.

19. The method of claim 18, wherein the customer requirements further include constraints.

20. The method of claim 18, wherein the determining to meet the certain customer requirements includes prioritizing use-cases.

21. The method of claim 20, wherein the customer performs the prioritizing use-cases step.

22. The method of claim 18, wherein the determining to meet the certain customer requirements includes assigning use-cases.

23. The method of claim 22, wherein a development team member performs the assigning use-cases step.

24. The method of claim 18 further comprising a step of developing acceptance tests based on the use-cases, wherein the acceptance tests are used to test whether the coded components of the application meet the certain customer requirements.

25. The method of claim 24 further comprising a step of acceptance testing of the coded components of the application using the acceptance tests.

26. The method of claim 25, wherein the executed development cycle is a first development cycle, the method further comprising executing a second development cycle if the coded components of the application fail the acceptance testing.

27. The method of claim 13, wherein the designing components step includes designing a class based on one or more of the certain customer requirements.

28. The method of claim 27, wherein the designing classes step uses class, responsibility, collaborator (CRC) cards.

29. The method of claim 28, wherein the designing classes step further includes:
identifying candidate classes on the CRC cards;
adding responsibilities;
consolidating classes based on the responsibilities; and
re-factoring classes based on the responsibilities.

30. The method of claim 29, wherein the designing classes step further includes:
adding collaborating classes;
consolidating classes based on the collaborating classes; and
re-factoring classes based on collaborating classes.

31. The method of claim 30, wherein the designing classes step further includes:
testing classes to ensure that they perform all the functions needed by the one or more of the certain customer requirements.

32. The method of claim 13 wherein the development cycle has a duration of four weeks.

33. The method of claim 13 wherein the executing the development cycle includes executing four design cycles.

34. The method of claim 13 wherein each design cycle has a duration of one week.

35. The method of claim 13 wherein executing one or more design cycles includes executing five construction cycles.

36. The method of claim 13 wherein each construction cycle has a duration of one day.

37. The method of claim 13 further comprising executing a startup phase.

38. An application developed according to the method of claim 13.
